(19) United States
(12) Patent Application Publication
(10) Pub. No.: US 2026/0349642 A1
(43) Pub. Date: Nov. 5, 2026

(54) METHODS AND SYSTEMS FOR MIRRORING PERSONAL ELECTRONIC DEVICES TO DISPLAY UNITS ON VEHICLES

(71) Applicant: IdeaNova Technologies, Inc., Naperville, IL (US)

(72) Inventor: Juraj Siska, Naperville, IL (US)

(21) Appl. No.: 19/194,715

(22) Filed: Apr. 30, 2025

(51) Int. Cl. G06F 3/14; B64D 11/00

(52) U.S. Cl. CPC G06F 3/1454; B64D 11/00151

(57) ABSTRACT

Methods and systems allow users to mirror or cast content from personal electronic devices. Specifically, the methods and systems of the present invention utilize mirroring or casting technologies embedded in personal electronic devices for mirroring or casting the content from the user's personal electronic device to the user's seatback screen embedded in passenger seats or other displays on aircraft, buses, trains, and other like transportation vehicles.

### TECHNICAL FIELD

The present invention relates to methods and systems mirroring content from personal electronic devices. Specifically, the methods and systems of the present invention utilize mirroring technologies embedded in personal electronic devices for casting and/or mirroring the content from the personal electronic devices to seatback screens embedded in passenger seats or other displays on aircraft, buses, trains, and other like transportation vehicles.

### BACKGROUND

Certain personal electronic devices have the ability to duplicate (called “mirroring”) or casting content from the personal electronic devices to compatible devices, typically screens such as smart televisions or other like screens, or audio devices. Typically, the ability to mirror or cast content is done where the personal electronic device and the compatible device is on the same network server; however, mirroring or casting may also be done on a peer-to-peer connection between the personal electronic device and the compatible device. The personal electronic device typically searches for compatible devices (either on the server or through a peer-to-peer connection protocol). Once a compatible device is found, the personal electronic device requests access to the compatible device for content sharing. The content may then be displayed or played from the personal electronic device through the compatible device through the server connection or through the peer-to-peer connection.

The transportation industry has faced significant challenges in bringing entertaining and other media content to passengers on airlines. Oftentimes, airlines utilize a proprietary entertainment and media content feed that may provide limited options to users thereof, using an entertainment and other media content service resident on the transportation vehicles themselves. These types of systems can only offer passengers a limited amount of content, which must be updated periodically. Such a system requires a large amount of memory space to hold such content and space on transportation vehicles is often very limited. Moreover, the content must be periodically updated to ensure that entertainment and other media content options are current and diverse. Updating entertainment or other media content requires time and effort to upload the new content. And if something goes awry during the uploading of content, passengers may suffer by being without a full panoply of entertainment or other media content options.

Some transporation vehicles offer onboard wi-fi connections through resident servers where a user can utilize the wi-fi connection to the resident server to stream content to their personal electronic device. However, such a system limits the users to viewing such content on their personal electronic device's screens, which often are very small and difficult to view.

Alternatively, airline wi-fi connectivity may allow a user to select among entertainment and other media content options through their seatback display unit or other like displays. However, providing wi-fi connectivity to users often requires complicated systems, including menus, payment systems, and other like modules, to bring the entertainment and other media content options to the seatback display. Again, if something goes wrong with the systems within the seatback display, the user can be without entertainment or other media content options. Moreover, the use of onboard Internet by several people may slow down the connection, causing the content to not display correctly. For example, a modern aircraft can hold several hundred people. Each person that may utilize onboard Internet for entertainment content can slow down the content streaming to their device and/or to the seatback display.

A need, therefore, exists for improved entertainment content systems and methods for airlines or other transportation means. Specifically, a need exists for improved media content systems and methods that allow users to either store their own media content or stream their own entertainment or other media content to their own personal entertainment devices. More specifically, a need exists for improved media content systems and methods that provide users with easy access and control over their own entertainment or other media content options when using aircraft, buses, trains, or other like vehicles for transportation.

Moreover, a need exists for improved media content systems and methods that provide users with the ability to mirror or cast entertainment or other media content from their personal electronic devices on aircraft, buses, trains, or other like transportation modes Specifically, a need exists for improved media content systems and methods allowing users to mirror or cast entertainment or other media content to compatible devices on aircraft, buses, trains, or other like vehicles. More specifically, a need exists for improved media content systems and methods allowing users to mirror or cast entertainment or other media content from their personal electronic devices to their seatback displays, offering both the ease of use, access, control, and security of using their own personal electronic devices with the larger and more comfortable displays in their seatbacks.

### SUMMARY OF THE INVENTION

The present invention relates to methods and systems mirroring content from personal electronic devices. Specifically, the methods and systems of the present invention utilize mirroring technologies embedded in personal electronic devices for casting and/or mirroring the content from the personal electronic devices to seatback screens embedded in passenger seats or other like displays on aircraft, buses, trains, and other like transportation vehicles.

To this end, in an embodiment of the present invention, a method for mirroring or casting media content on a vehicle is provided. The method comprises the steps of: providing a personal electronic device configured to store or stream media content; providing a plurality of screen devices, each screen device having a display; providing a server, wherein the server is connected to the screen devices; providing a service on the screen device wherein the service facilitates casting or mirroring media content from the personal electronic device to one of the plurality of screen devices; connecting the personal electronic device to the server; requesting connection between the personal electronic device and the one of the plurality of screen devices through the application; confirming the request from the personal electronic device on the one of the plurality of screen devices, wherein the confirmation is sent through the application to the personal electronic device; and casting or mirroring the media content from the personal electronic device on the one of the plurality of screen devices.

In an embodiment, the plurality of seatback screen devices is connected to the server via a wired or wireless connection.

In an embodiment, the display on the screen device is, optionally, a touchscreen.

In an embodiment, the step of confirming the initial request is done by selecting a confirmation prompt on the screen device.

In an embodiment, the personal electronic device is connected to the server via a wired or wireless connection.

In an embodiment, the wired or wireless connection is a network connection.

In an embodiment, the server has access to, optionally, the Internet.

In an embodiment, the method further comprises the step of: providing a router wherein the server is connected to the router and the plurality of screen devices is connected to the router.

In an embodiment, the personal electronic device is connected to the server via the router.

In an embodiment, the method further comprises the step of: activating a casting or mirroring application on the personal electronic device before casting or mirroring the media content from the personal electronic device on the one of the plurality of screen devices.

In an alternate embodiment of the present invention, a system for mirroring or casting media content on a vehicle is provided. The system comprises: a personal electronic device configured to store or stream media content; a plurality of screen devices, each screen device having a display; a server, wherein the server is connected to the screen device; and an application on the server wherein the application facilitates casting or mirroring media content from the personal electronic device to one of the plurality of screen devices, wherein the system mirrors or casts media content from the personal electronic device to the one of the plurality of screen devices by: connecting the personal electronic device to the server; requesting connection between the personal electronic device and the one of the plurality of screen devices through the application; confirming the request from the personal electronic device on the one of the plurality of screen devices, wherein the confirmation is sent through the application to the personal electronic device; and casting or mirroring the media content from the personal electronic device on the one of the plurality of screen devices.

In an embodiment, the plurality of screen devices is connected to the server via a wired or wireless connection.

In an embodiment, the display on the seatback screen device is, optionally, a touchscreen.

In an embodiment, the step of confirming the request is done by selecting a confirmation prompt on the screen device.

In an embodiment, the personal electronic device is connected to the server via a wired or wireless connection.

In an embodiment, the wired or wireless connection is a network connection.

In an embodiment, the server has access to, optionally, the Internet.

In an embodiment, the system further comprises: a router wherein the server is connected to the router and the plurality of screen devices is connected to the router.

In an embodiment, the personal electronic device is connected to the server via the router.

In an embodiment, the system further comprises: a casting or mirroring application on the personal electronic device, wherein the casting or mirroring application is activated on the personal electronic device before casting or mirroring the media content from the personal electronic device on the one of the plurality of screen devices.

It is, therefore, an advantage and objective of the present invention to provide improved entertainment content systems and methods for airlines or other transportation means.

Specifically, it is an advantage and objective of the present invention to provide improved media content systems and methods that allow users to either store and share their own entertainment or other media content or stream their own entertainment or other media content from their own personal entertainment devices.

More specifically, it is an advantage and objective of the present invention to provide improved media content systems and methods that provide users with easy access and control over their own entertainment or other media content options when using aircraft, buses, trains, or other like vehicles for transportation.

Moreover, it is an advantage and objective of the present invention to provide improved media content systems and methods that provide users with the ability to mirror or cast entertainment or other media content from their personal electronic devices on aircraft, buses, trains, or other transportation means.

Specifically, it is an advantage and objective of the present invention to provide improved media content systems and methods allowing users to mirror or cast entertainment or other media content to compatible devices on aircraft, buses, trains, or other like transportation vehicles.

More specifically, it is an advantage and objective of the present invention to provide improved media content systems and methods allowing users to mirror or cast entertainment or other media content from their personal electronic devices to their seatback displays, offering both the ease of use, access, control, and security of using their own personal electronic devices with the larger and more comfortable displays in their seatbacks.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a method of screen mirroring or casting of a personal electronic device on a seatback screen device embedded in transportation vehicle passenger seats in an embodiment of the present invention.

### DETAILED DESCRIPTION OF THE PRESENTLY PREFERRED EMBODIMENTS

The present invention relates to methods and systems mirroring content from personal electronic devices. Specifically, the methods and systems of the present invention utilize mirroring technologies embedded in personal electronic devices for casting and/or mirroring the content from the personal electronic devices to seatback screens embedded in passenger seats or other like displays on aircraft, buses, trains, and other like transportation vehicles.

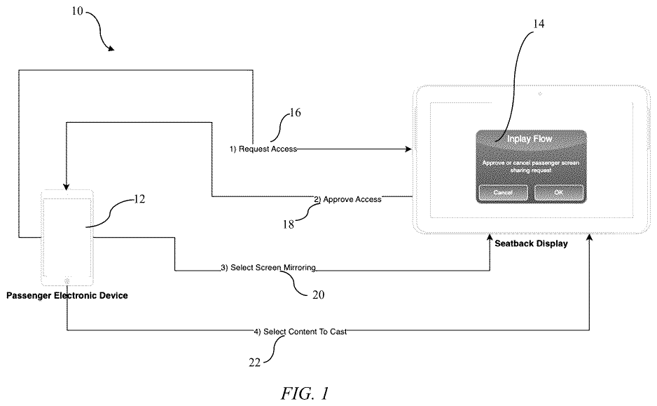

Now referring to the figures, wherein like numerals refer to like parts, FIG. 1 illustrates a method 10 of screen mirroring or casting of a personal electronic device on a seatback screen device embedded in passenger seats, or other like display devices, on aircraft, buses, trains, or other like transportation vehicles, in an embodiment of the present invention. Specifically, the method 10 utilizes a personal electronic device 12, such as a smart phone, a tablet computer, a laptop computer, or other like personal electronic device 12 that may be configured to retrieve and/or store audio data, video data, game data, other digital media, such as, for example, application data, text data, documents, presentations, multimedia presentations, spreadsheets, or other like data (“media content”) thereon. For example, the personal electronic device 12 may be connectable to the Internet, such as through a cellular network and/or a wi-fi network for obtaining and downloading media thereon. The personal electronic device 12 may alternately store the media or play the media, such as by streaming the same as it receives the datastream.

The method 10 may further comprise a screen device 14, such as a screen display embedded in a passenger seat or other like display device, for use by a passenger on an aircraft or other like transportation vehicle, such as, for example, a boat, a train, a bus, or other like transportation vehicle. Typically, in an aircraft, for example, the screen device 14 may be embedded in the back of a seat in front of a passenger for the passenger to view and use but may also include other standalone display devices or monitors that are on the vehicles that are not specifically embedded within the backs of the seats of the vehicle.

The method 10 may further comprise a server (not shown) forming a local area network with a router, for example, to which one or more personal electronic devices 12 and one or more screen devices 14 are connected, either through a hardwired connection, such as via an ethernet cable or the like, or over a wireless connection, such as, for example, a wi-fi connection. Resident on the server may be an application that facilitates the conjoining of one of the personal electronic devices 12 and one of the screen devices 14. Specifically, the application may listen for requests for connection from one or more personal electronic devices 12 and may further facilitate the mirroring or casting of the media content from the one or more personal electronic devices 12 to one or more screen devices 14, respectively. The method 10 may therefore allow for a single personal electronic device 12 to connect with one screen device 14. Preferably, the method provides security, as described below, to ensure that the personal electronic device of a user is connected to and mirroring or casting media content to the respective screen device 14 in front of or otherwise associated with the user, such as the seatback screen device associated with the seat the user may presently be in.

The personal electronic device 12 may connect to a network on the aircraft or other transportation vehicle and may, therefore, interact through the server thereof to the application resident thereon, as described above. The personal electronic device 12 may request access via step 18 to one of a plurality of screen devices 14, namely the seatback screen device associated with the seat that the user of the personal electronic device 12 is seated. Specifically, the application resident on the server may present an option to the personal electronic device 12 for selecting or otherwise inputting his or her seat number when queried by the application.

Upon requesting access, the application resident on the server and associated with the plurality of screen devices 14 and, specifically, the screen device 14 requested by the user of the personal electronic device 12 based on his or her seat number, may present, via the application resident on the server, a prompt on the screen device 14 for confirmation to the user to grant access to connect the personal electronic device 12 and the specific screen device 14. If the user approves thereof via step 20, a connection is established between the personal electronic device 12 and the screen device 14 associated with the user of the personal electronic device 12 based on the seat number. The prompt on the screen device 14 may present identifying information concerning the identity of the user and/or the personal electronic device 12 so that the user may be assured that the user is granting access to himself or herself, and not another person.

For example, the plurality of screen devices 14 may optionally be touchscreens and the prompt for confirmation may be confirmed or denied by touching the touchscreens thereof. Of course, it should be noted that any input device may be associated with the plurality of screen devices 14 and should not be limited as described herein.

Once the connection is established between the user's personal electronic device 12 and the screen device 14 associated with the user based on his or her seat number and once access is granted by the user between the user's personal electronic device 12 and the screen device 14, the user of the personal electronic device 12 may subsequently select to mirror or cast content from his or her personal electronic device 12 via a casting or mirroring application resident on his or her personal electronic device, via step 22. Specifically, the casting or mirroring application may a native application already be resident on the user's personal electronic device 12. For example, many personal electronic device operating systems contain an application that allows casting or mirroring to compatible devices, such as, for example, Apple's Airplay protocol or Alphabet's Google Cast protocol.

Once casting or mirroring is activated by the user of his or her personal electronic device 12, the user may select content on his or her personal electronic device 12 to cast or mirror to the screen device 14 connected therewith. For example, Apple devices, such as iPhones or iPads using iOS operating system may use Apple's proprietary mirroring application AirPlay™. Likewise, Alphabet's smartphones using Google operating systems may use Google Cast™ to cast or mirror content. Therefore, the users' personal electronic devices may utilize the applications resident thereon without requiring additional applications to be downloaded and activated making it convenient for users thereof.

The media content on the user's personal electronic device 12 may be stored and played back through the personal electronic device 12 and cast or mirrored to the screen device 14, as described herein. Alternatively, the media content may be streamed by connection to a network, such as the Internet, and cast or mirrored on the seatback screen device 14, as described herein.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. A method for mirroring or casting media content on a vehicle comprising the steps of:
providing a personal electronic device configured to store or stream media content via a casting application;
providing a plurality of seatback screen devices, each seatback screen device having a display;
requesting connection between the personal electronic device and the one of the plurality of seatback screen devices through the application;
confirming the request from the personal electronic device on the one of the plurality of screen devices, wherein the confirmation is sent to the personal electronic device; and
casting the media content file through the application from the personal electronic device on the one of the plurality of screen devices without processing the media content file for properly displaying the media content file on the one of the plurality of screen devices.

2. The method of claim 1 wherein the plurality of seatback screen devices is connected to the server via a wired or wireless connection.

3. The method of claim 1 wherein the personal electronic device comprises an operating system, and further wherein the application for casting from the personal electronic device is native to the operating system on the personal electronic device.

4. The method of claim 1 wherein the step of confirming the request is done by selecting a confirmation prompt on the one of the plurality of seatback screen devices.

5. (canceled)

6. (canceled)

7. (canceled)

8. The method of claim 1 further comprising the step of:
providing a router wherein each of the plurality of seatback screen devices is connected to the router.

9. The method of claim 1 wherein the vehicle is an aircraft.

10. (canceled)

11. A system for casting media content on a vehicle comprising:
a personal electronic device configured to store a media content file and comprising an application for casting the media content file from the personal electronic device;
a plurality of seatback screen devices, each seatback screen device having a display that runs a casting service from the personal electronic device,
wherein the system the casts media content file from the personal electronic device to the one of the plurality of seatback screen devices by:
connecting the personal electronic device to the server;
requesting connection between the personal electronic device and the one of the plurality of seatback screen devices through the application;
confirming the request from the personal electronic device on the one of the plurality of seatback screen devices, wherein the confirmation is sent through the application to the personal electronic device; and
casting the media content file from the personal electronic device on the one of the plurality of seatback screen devices without processing the media content file for properly displaying the media content file on the one of the plurality of screen devices.

12. The system of claim 11 wherein the plurality of seatback screen devices is connected to the server via a wired or wireless connection.

13. The system of claim 11 wherein the personal electronic device comprises an operating system, and further wherein the application for casting from the personal electronic device is native to the operating system of the personal electronic device.

14. The system of claim 11 wherein the step of confirming the request is done by selecting a confirmation prompt on the screen device.

15. (canceled)

16. (canceled)

17. (canceled)

18. The system of claim 11 further comprising:
a router wherein the plurality of seatback screen devices is connected to the router.

19. The system of claim 11 wherein the vehicle is an aircraft.

20. (canceled)
